(19) United States
(12) Patent Application Publication
(10) Pub. No.: US 2015/0173123 A1
(43) Pub. Date: Jun. 18, 2015

(54) Call Termination to a ICS User

(71) Applicants: Volker Luessem, Erfstadt (DE); Claudia Mayntz, Herzogenrath (DE); Karl-Peter Ranke, Herzogenrath (DE)

(72) Inventors: Volker Luessem, Erfstadt (DE); Claudia Mayntz, Herzogenrath (DE); Karl-Peter Ranke, Herzogenrath (DE)

(73) Assignee: Telefonaktiebolaget L M Ericsson (pulb), Stockholm (SE)

(21) Appl. No.: 14/401,046

(22) PCT Filed: May 16, 2012
(86) PCT No.: PCT/EP2012/059149

§ 371 Date: Nov. 13, 2014

(51) Int. Cl. H04W 76/06; H04L 29/06

(52) U.S. Cl. CPC H04W 76/066; H04L 65/1073

(57) ABSTRACT

The invention relates to techniques for terminating a call to a user in a mobile telecommunication network having a circuit switched CS access and service execution centralized in IP Multimedia Subsystem IMS. It is proposed to send the IMSI number of the user to the IMS during a registering of the user in the IMS, preferably with the SIP REGISTER message. Further when a call terminating request is received in the IMS, a SIP INVITE is generated and the IMSI number is provided to the MSC Server. The MSC server contacts the VLR for the purpose of call termination and in case the user is not found in the VLR, a restoring procedure is performed by contacting a HLR using the IMSI number and by providing the user's data to the VLR. The restoring procedure may be performed by means of the MAP restore procedure.

### TECHNICAL FIELD

The present invention relates to IP Multimedia Subsystem, IMS. In particular the present invention is applicable for terminating a call to a user having a CS access and executing services that are centralized in IMS, thus for a so called ICS (IMS Centralized Services) user.

### BACKGROUND

The IP Multimedia Subsystem IMS has been defined to provide cellular access to the services of the Internet in order to support telephony and multimedia services. The IMS uses packet-switched technology, in particular IP-network for provision of services. Thus, the strength of IMS is the provision of enhanced Services, for example multimedia services combining voice and data. Further, the usage of IP-network as a single underlying standard allows an easy and fast service deployment.

If there is no full radio coverage capable for a packet switched access, that is, the user is not able to connect to a packet switched access network and thus to the IMS, then the circuit switched access is used under certain conditions. The concept of using a circuit switched access for accessing IMS is called IMS Centralized Services, ICS, and is developed for delivery of consistent services to the users regardless of the attached access type. This service is defined in 3GPP TS 23.292 V11.2.0 (2012-03), 3rd Generation Partnership Project Technical Specification Group Services and System Aspects, IP Multimedia Subsystem (IMS) centralized services, Release 11.

A Session Initiation Protocol SIP has been chosen in the IMS for signaling between the user's equipment UE and the IMS as well as between the network components within the IMS. In order to be able to use the IMS service, the communicating nodes have to support IMS.

The mobile networks are characterized by the movement of the users. In order to keep track on the user's location, there are a number of procedures for updating the UE position, like for example the so called Location Update Procedure.

In the following an overview of the Location Update Procedure in a circuit switched (CS) network is described.

Usually in a CS network a number of MSCs is provided, wherein a MSC is responsible for users being located in location areas being assigned to the MSC. Changing of the responsible MSC due to user's movement implies initiation of an location update procedure aiming to register the user in a new MSC and de-register from the old MSC by performing the necessary updates in respect therewith in the corresponding nodes. After entering a new location area, the terminal sends a location update request to the new MSC. When receiving this message, the MSC identifies the subscriber to be new in its responsibility and therefore the HLR is contacted for updating the location information in respect to the responsible MSC/VLR. Upon reception of the location update message, the HLR informs the old MSC/VLR that the subscriber has roamed into a new MSC/VLR area in order to deregister said user from the old MSC/VLR.

The subscriber data in the VLR are needed for example in case of mobile terminating call to locate the user.

In order to access and execute services in the IMS, an ICS user is to be registered in the IMS. The result of the registration procedure is also the determination of the MSC address, so that in case of sending a call termination to the ICS user, the correct MSC is addressed by IMS. For the purpose of call termination, the MSC contacts the VLR to get the user's location information. (The registration of the user in the IMS with the MSC address determination is described in more details in respect to FIG. 2.)

However when the subscriber data of the called ICS subscriber have been lost in the VLR, for example due to recovery actions, the terminating call fails. Currently there is no means to retrieve the subscriber data during the terminating call setup procedure for a ICS user. The only chance to get said data again is at the next location update from the UE. Consequently, an ICS subscriber might not be reachable for terminating calls for quite some time because it might take hours until the next Location Update is performed and during this period of time the user is not reachable although he is attached to the network and ready to receive calls.

### SUMMARY

There is a demand for a technique for providing a call termination to a user in a mobile telecommunication network having a CS access and service execution in IMS. In particular, there is a demand for a technique for providing a call termination to a user in a mobile telecommunication network having a CS access and service execution in IMS in situations where the VLR data of the user has been lost.

The invention is embodied in independent claims. Advantageous embodiments are described in the dependent claims.

The demand is satisfied with a method for terminating a call to a user in a mobile telecommunication network having a CS access and service execution centralized in IMS. The method comprises the steps of receiving a terminating call request for the user from the IMS where he has been registered before and wherein the request comprises the IMSI number of the user and wherein the IMSI is provided to the IMS during a registering of the user in the IMS. Further a subscriber visiting data base is contacted for providing user's data required for call termination using the IMSI. In the next step the terminating call towards the user is established using the received user's data wherein in case the user is not found in the subscriber visiting database performing a restoring procedure by contacting a global subscriber database using the IMSI and by providing the user's data to the subscriber visiting database.

According to one aspect, it is proposed to send the IMSI number in a SIP REGISTER message during a registration procedure. In one implementation, the IMSI number is included in the Contact header of the SIP Register message. The information in the Contact header is copied during the generation of the INVITE message, thus by initiating the call terminating procedure, without any analysis of the content. Thus, the impact on the actual standard is narrow. The advantage thereof is that the solution according the present invention can be used without affecting an existing IMS implementation.

A further embodiment is to provide in addition to the IMSI number an identification at IMS Registration, that identifies the IMSI as being an IMSI number. In one implementation, a dedicated string or prefix is included together with the IMSI in the Contact header of the SIP Register message that identifies the IMSI as to be used for ICS.

Further it is proposed that the received terminating call request for the user is a SIP INVITE message. In one implementation, the IMSI and the said identification of the IMSI is included in a Request-URI of the SIP INVITE message.

In a further embodiment it is proposed to extract the IMSI number from the received terminating call request. This extraction may be triggered by the reception of the said identification of the IMSI in the terminating call request.

In an embodiment it is proposed that the restoring procedure comprises further the step of registering or deregistering of the user in the IMS. Thus in case the user data is restored it is proposed to register the user in the IMS again in order to assign or update the restored address of the CS network with the addresses of the IMS. However in case the user data could not be restored or the user could not be found (for example after paging the user) it is proposed to deregister the user from the IMS. In a preferred solution the registration and deregistration is done by means of the SIP REGISTER message carrying accordingly different parameters.

In a further embodiment it is proposed that the restoring procedure comprises the step of contacting a HLR using MAP Restore Data and determining the user's data by using the IMSI. In the next step the user's data is provided to the VLR using MAP Insert Subscriber Data and finally the user is registered in the IMS by sending a SIP REGISTER message towards the IMS. Alternatively, the user may be deregistered from the IMS, in case the user could not be found or the restoring procedure failed.

The abovementioned demand is also satisfied by a device adapted to terminate a call to a user in a mobile telecommunication network having a CS access and service execution in IMS. Said device comprises a receiver adapted to receive a terminating call request for the user from the IMS, wherein the request comprises an IMSI number of the user and wherein the IMSI is provided to the IMS during a registering of the user in the IMS. Further a sender is provided which is adapted to contact a subscriber visiting data base for providing user's data required for call termination using the IMSI. Further the device comprises a processor which is adapted to establish the terminating call towards the user using the received user's data wherein in case the user is not founded in the subscriber visiting database performing a restoring procedure by contacting a global subscriber database using the IMSI and by providing the user's data to the subscriber visiting database.

The sender, the receiver and the processor are connected with each other in a way that allows exchange of information required to perform the embodiments of the present invention.

In a preferred embodiment the device is a MSC Server.

Further the device node is adapted to perform all steps as claimed in connection with the method which is to be performed in said node.

### BRIEF DESCRIPTION OF THE DRAWINGS

In the following, the invention will further be described with reference to exemplary embodiments illustrated in the figures, in which:

FIG. 1 illustrates schematically the IMS Service Centralization and Continuity Reference Architecture, according to 3GPP TS 23.292;

FIG. 2 illustrates signalling exchange during a registering a user in IMS, according to 3GPP TS 23.292;

FIG. 3 illustrates signalling exchange during a registering of a user in IMS according to an embodiment of the invention;

FIG. 4 illustrates an extract of signalling exchange during call termination to a user with CS access and with services centralized in IMS, according to 3GPP TS 23.292;

FIG. 5 illustrates an extract of signalling exchange during call termination to a user founded in the CS with services centralized in IMS according to an embodiment of the invention;

FIG. 6 illustrates an extract of signalling exchange during call termination to a user being not found in the CS access, with services centralized in IMS according to an embodiment of the invention;

FIG. 7 is a flow diagram exemplarily illustrating an operation of the embodiment of the invention performed in the receiver device;

FIG. 8 schematically illustrates functional components according to an embodiment of the invention.

### DETAILED DESCRIPTION

In the following description, for purposes of explanation and not limitation, specific details are set forth, such as particular network environments and communication standards etc., in order to provide a thorough understanding of the current invention. It will be apparent to one skilled in the art that the current invention may be practiced in other embodiments that depart from these specific details.

In the following it is proposed that the user's data includes any data which are administrated for a user in the network database. Said data may be for example data required for authentication of the user in the system or for determining the location of the user like for example the location information. Furthermore, any user addresses which are associated with the user are part of the user's data. This is to be seen as examples and does not provide any limitation to the patent application.

The visiting subscriber data base in the context of the present invention refers to a VLR and the global subscriber data base to a HLR. However this should not be seen as any limitation.

Preferably the CS network is any mobile telecommunication network, thus a network operating according to GSM, GPRS, UMTS or any wireless system providing a circuit switched access.

The user equipment refers to any terminal being adapted to have service execution centralized in IMS while roaming in a circuit-switched network, so by using a CS access. The term ‘user’ or ‘ICS user’ refers to a subscriber that is marked in the global subscriber data base as having his service execution centralized in IMS.

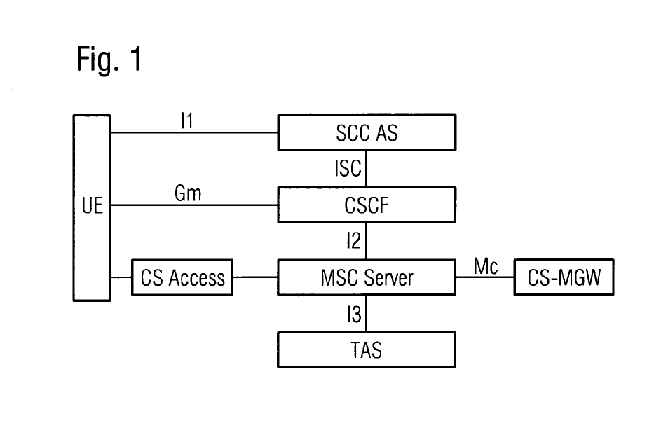

In the following simplified network architectures of IMS Centralized Service (ICS) according to FIG. 1 is described. In particular nodes being involved in provision of service in IMS architecture are mentioned. As depicted in FIG. 1, the components of the IMS system are the Service Centralization and Continuity Application Server (SCC AS), the Call Session Control Function (CSCF), MSC Server, CS-Media Gateway (CS-MGW) and User Equipment (UE). Between the nodes there are the corresponding interfaces.

According to FIG. 1 the UE uses a CS Access for communication with the IMS, in particular for the communication with the MSC Server. The SCC AS is a home network based IMS Application that provides functionality required to enable IMS Centralized Services. The CSCF acts as a call server and handles call signaling, it supports and controls multimedia sessions and performs address translation functions. The CSCF can be functionally decomposed to S-CSCF, I-CSCF and P-CSCF. The Proxy-CSCF (P-CSCF) is the first contact point for a user. In the ICS concept the MSC Server takes the role of a P-CSCF and forwards a registration request received from the User Equipment UE to an I-CSCF.

The Interrogating-CSCF (I-CSCF) is located at the edge of a domain and is the first contact address to other operator's networks. The IP address of the I-CSCF is published in the Domain Name System (DNS), so that remote servers can use it to forward packets to the particular I-CSCF domain.

The Serving-CSCF (S-CSCF) is the central node of the SIP signaling plane. Among other tasks, it performs session control and is responsible for communicating with the HSS, which is the user data base in the IMS.

The MSC Server is enhanced for the support of ICS. Thus, in addition to the standard MSC Server behavior, an MSC Server is adapted for example to process the user-network signaling received over the CS access for interworking with IMS SIP and vice versa.

The I2 interface provided between the MSC Server and CSCF is used to route service control signaling between the MSC Server enhanced for ICS and the home IMS.

In the following an overview of a location update in a circuit switched GSM or WCDMA network is provided.

If a UE detects that it has entered a new location area, an updating request message that contains the identity of the UE and the identity of the old location area is sent to the MSC/VLR serving that new location area. MSC/VLR is an embodiment of a subscriber visiting data base, which administrates the user's data of a user being currently handled by said MSC/VLR. In case the UE is already registered in the MSC/VLR, the user's data, as stored in the VLR, are used. Otherwise the appropriate HLR or the previously used MSC/VLR are contacted. In case of a new MSC/VLR the user's data from the old MSC/VLR are obtained and saved. Additionally the entries in the HLR, which is an embodiment of a global subscriber database administrating the contact data of MSC/VLR handling currently a particular user, are updated.

The updating procedure is further used as a trigger to register a user to the IMS, when the user is to be registered to the IMS, thus if the subscriber is using IMS Centralized Services. The mechanism of registration an UE in the IMS is described in 3GPP TS 23.292 V11.2.0 (2012-03), 3rd Generation Partnership Project Technical Specification Group Services and System Aspects, IP Multimedia Subsystem (IMS) centralized services, Release 11.

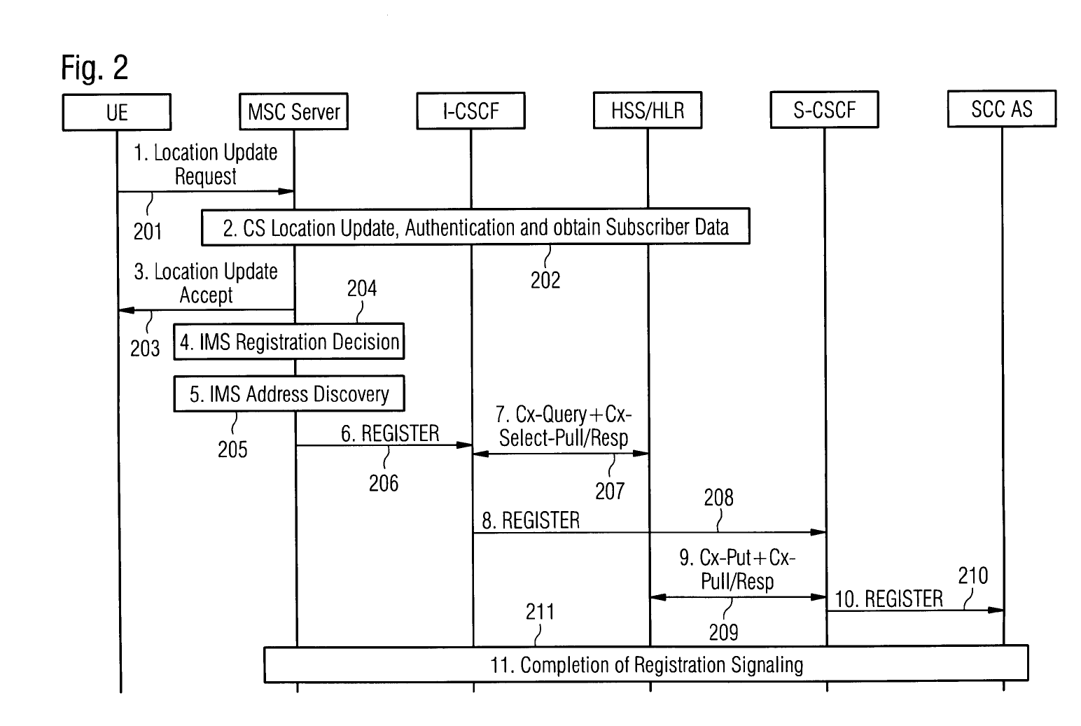

In the following an overview for registration of a UE in an IMS is described according to FIG. 2. FIG. 2 shows a signaling exchange between network nodes.

FIG. 2 depicts a UE communicating with an MSC server, which is enhanced for ICS, thus having the ability to communicate with I-CSCF over the I2 interface (as depicted in FIG. 1). Further communication nodes are the HSS/HLR, S-CSCF and the SCC AS.

In the first step, 201, the UE sends a Location Update Request towards the CS network, which performs standard CS location update, authentication and obtains subscriber data by contacting the MSC Server as described above. After performing a successful Location Area Update procedure to the UE, the MSC Server receives subscriber data from the HSS/HLR, 202 and a Location Update Accept is returned to the UE, 203. In the next step, 204, the MSC Server decides to initiate IMS registration for this user. During the Location Update Procedure the MSC Server receives also an indication from the HSS/HLR whether the user is subscribed in the IMS, thus whether a IMS registration for said user is desired. If a user is not subscribed to the IMS, the MSC server handles the subscriber as a usual MSC. Furthermore, if the subscriber is already registered in IMS via this MSC Server, no IMS registration is triggered by the Location Update procedure.

As a consequence of the Location Update procedure, the MSC Server derives a domain name from the subscriber's identity and discovers the address of the appropriate I-CSCF, 205. IMSI (International Mobile Subscriber Identity) of the subscriber is an embodiment for the subscriber's identity.

In a GSM or WCDMA network, when a UE is switched on, the IMSI attach procedure is executed. This procedure is required for the MSC/VLR to register the UE in the network. Usually in CS networks, the International Mobile Subscriber Identity (IMSI) and the Temporal Mobile Subscriber Identity (TMSI) are used for user identification. The IMSI is used for example by the HLR when locating a VLR in case of mobile terminating call, when performing a location update or by call terminating operation to determine the called user. With the IMS, additional identities are implemented, namely a private user identifier (User Id), a temporary public User Id and a public User Id. Said user IDs are used to identify the user in the IMS.

In one embodiment in the IMS it is proposed to derive the needed IMS addresses, IMPI and IMPU from the IMSI. Both IMPI and IMPU are preferably Uniform Resource Identifier (URIs), that are alphanumeric identifiers, like the SIP URI for example in the form like sip:user@example.com.

In the following the IMPI and IMPU are described in more details.

The IP Multimedia Private Identity (IMPI) is a unique permanently allocated global identity assigned by the home network operator, like username@example.com. Said IMPI is used, for example, for registration, authorization, administration, and accounting purposes. As already mentioned it may be derived from the IMSI. In this case, the complete IMSI is taken as the username and the example.com as domain name is derived form the IMSI. An IMSI comprises Mobile Country Code MCC, 3 digits, 2 or 3 digits are foreseen for Mobile Network Code (MNC) and the rest is Mobile Subscriber Identification Number (MSIN) identifying the mobile subscriber within a PLMN. Thus, if the IMSI is 234150999999999 (MCC=234, MNC=15), the private user identity then takes the form like for example “234150999999999@ims.mnc015.mcc234.3gppnetwork.org”. Herein the ims.mnc015.mcc234.3gppnetwork.org is pointing to home network domain. Thus, the domain name is derived form the MNC and MCC, like: mnc<MNC>.mcc<MCC>0.3gppnetwork.org by adding the label “ims.” to the beginning of the domain.

In the frame of a public identity, two different numbers are used, a public User Id and a temporary public User Id. The temporary public User Id is used as a first contacting address, for example during the registration phase said address is used to contact the IMS to get the public User Ids. There can be multiple public User Ids per one private User ID. The public User Ids can also be shared with another phone, so that both can be reached with the same identity (for example, a single phone-number for an entire family).

In one embodiment of the IMS, the IP Multimedia Public Identity IMPU may be derived form the IMSI. In this case, the form of a SIP URI for a Public User Identity has the form like “sip:username@domain.com. Thus, the format is similar to the IMPI format with the additional header “sip”. Further the public User Id may be in form of an ISDN number. The IMPU is used by a user for requesting communications to other users.

The derivation of the IMPI and IMPU addresses is described in more detail in 3GPP TS 23.003 V11.1.0 (2012-03), Technical Specification Group Core Network and Terminals; Numbering, addressing and identification (Release 11).

Summarizing, at the end of step 205, the private and the temporary public user identity are derived. In some embodiments the purpose of the IMSI in the MSC Server is to derive some IMS identifiers, like the IMPI pr IMPU numbers.

Returning to FIG. 2, in the next step, 206, a SIP REGISTER message is sent to the home IMS network of the subscriber.

The format of such a SIP message is standardized and described in more details in RFC 3261 “SIP: Session Initiation Protocol”.

According to a different types of messages, which are to be sent, different formats with different parameters in the SIP message may be used.

A Request URI in a SIP message may be in general represented as following:

“sip:” [userinfo] hostport uri-parameters
or
“sips:” [userinfo] hostport uri-parameters

Herein the userinfo is optional. Hostport and uri-parameters are information regarding an address. Assuming that the address of the registering user is sip:j.doe@big.com, in this case the j.doe is included in the userinfo and the big.com identifies the hostport.

In the following the SIP REGISTER message is discussed in more details in connection with the format of a SIP message.

As described in more details in 3GPP TS 24.292 V11.0.0 (2012-03), 3rd Generation Partnership Project; Technical Specification Group Core Network and Terminals; IP Multimedia (IM) Core Network (CN) subsystem Centralized Services (ICS); Stage 3 (Release 11), the REGISTER message comprises defined fields. In this connection the fields are called headers. In the following table only some fields are mentioned

REGISTER sip: ics.mnc015.mcc234.3gppnetwork.org SIP/2.0
From:

<sip:234150999999999@ics.mnc015.mcc234.3gppnetwork.org>;ta
g=4fa3

To:

<sip:234150999999999@ics.mnc015.mcc234.3gppnetwork.org>

Contact:

<sip:[msc2.home1.net]>;expires=600000;+sip.instance=“<urn:
gsma:imei:90420156-025763-0>”;+g.3gpp.icsi-ref=“urn%3Aurn-
7%3gpp-service.ims.icsi.mmtel”;+g.3gpp.ics=“server”

Thus, the REGISTER message comprises in the REGISTER field the name of the home network domain that was derived from the subscribers IMSI. The “To” and “From” fields comprise the temporary public user identity that was also derived form the subscribers IMSI as described above. In the Contact header an IP address of the MSC Server is included. In the present examples, the MSC Server address is the address msc2.home1.net. According to the URI format corresponds the msc2.home1.net to the hostport. Furthermore, the Contact header contains an instance ID and a feature tag indicating that the MSC Server is acting as an MSC Server enhanced for ICS services.

Thus, the REGISTER message comprises the temporary public User Id and in the Contact header, the address of the MSC server, under which the user can be reached for further communications, for example during call termination. According to the standardized method, the information in the Contact header are copied by the generation of the INVITE message for terminating calls to the user.

Consequently, the IMS uses the address of the MSC Server in the Contact header to route mobile terminating calls to said MSC Server where the subscriber is attached to. The format of the address within the Contact header is a standardized SIP format as described above. Thus, the address has to have a valid SIP-URI or SIPS-URI address.

According to a preferred embodiment of the present invention it is proposed to send the IMSI number of the user in a SIP REGISTER message. The IMSI number may be included in any appropriate and preferably way in the SIP REGISTER message. In one embodiment it is proposed to include the IMSI in the Contact header of the SIP REGISTER message. The advantage is that the data in the Contact header remains transparent for the IMS. Thus, for example upon reception of the SIP REGISTER message, the IMS stores the information without analyzing it and uses said data as stored by generating for example a SIP INVITE message.

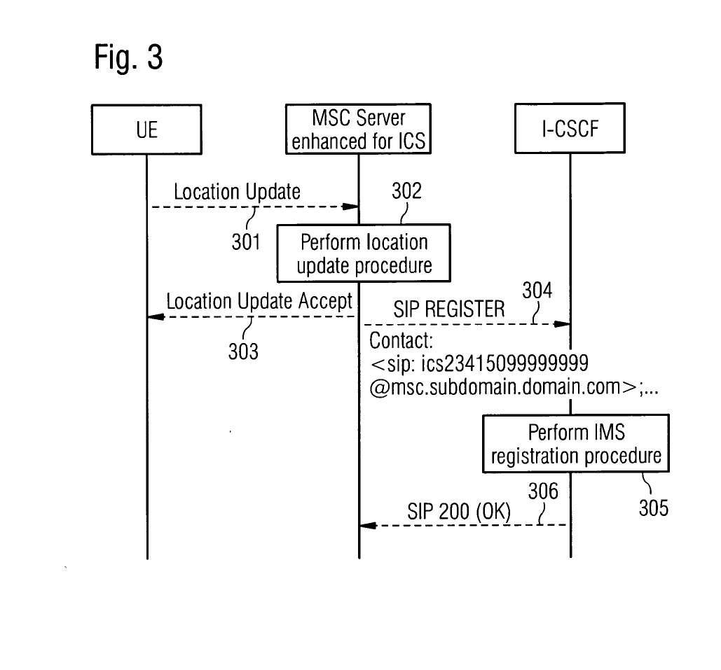

In the following an embodiment for the enhancement of the SIP REGISTER message is described in respect to FIG. 3.

FIG. 3 shows a signaling exchange between the UE, MSC Server and I-CSCF. In the steps 301-303 a standard location update is performed as described in connection with FIG. 2. In step 304, which corresponds to step 206 of FIG. 2, it is proposed to enhance the format of the SIP REGISTER message. In one embodiment of the invention it is proposed to encode the IMSI of the ICS subscriber in the userinfo part within the Contact header sent by the MSC Server at IMS registration.

Thus, according to one embodiment it is proposed to send additionally the IMSI of the subscriber into the IMS. In a preferred solution it is proposed to store the IMSI address in the S-CSCF, in order to use said IMSI during a terminating call. However for the nodes in the IMS the additional information remains transparent, since when receiving a REGISTER message said nodes takes the relevant information as received, as already mentioned.

In a further embodiment it is proposed to include an indication identifying the included information as IMSI address. The indication may be realized as a number prefix or a dedicated string in the userinfo part that identifies the number in the userinfo to be an IMSI. In FIG. 3 the IMSI number starts with the string “ics” indicating that the included information is an IMSI address. The advantage of this embodiment is to recognize by particular nodes, if necessary, that the included number is the IMSI address. For example it is easier for the MSC Server when receiving an INVITE message to recognize the IMSI number.

In respect to the above mentioned REGISTER message it is proposed to enhance the Contact header by adding the IMSI address into the Contact header. Thus, the contact header has to following format:

Contact:

<sip:ics234150999999999@msc2.home1.net>;expires=600000;+si
p.instance=“<urn:gsma:imei:90420156-025763-
0>”;+g.3gpp.icsi-ref=“urn%3Aurn-7%3gpp-
service.ims.icsi.mmtel”;+g.3gpp.ics=“server”

Alternatively also a dedicated hostport parameter for ICS calls could be used as an indication for the content of the included information. Thus, it is here proposed to introduce a corresponding identifier identifying that the message relates to a ICS call and the address is a IMSI address into the hostport field.

The remaining step in FIG. 3 corresponds to the remaining steps 207-211 of FIG. 2.

Returning to FIG. 2, the I-CSCF verifies by contacting the HSS/HLR, 207, that the incoming REGISTER origins from a trusted MSC Server and forwards the message to the S-CSCF, 208, which performs registration procedures with the HSS, 209 and the SCC AS, 210. Finally the IMS registration procedure is completed, 211.

In particular, the result of the registration procedure in the IMS is the provision of at least one public User ID. As already mentioned, a user may have a number of public User Ids. Said Ids are stored in the IMS and are provided for routing calls after the registration is completed.

As a consequence of the registration procedure, mobile originating calls from an ICS subscriber are routed from the MSC Server enhanced for ICS to IMS and mobile terminating calls to an ICS subscriber are routed from IMS to the MSC Server enhanced for ICS where the subscriber is registered for CS access.

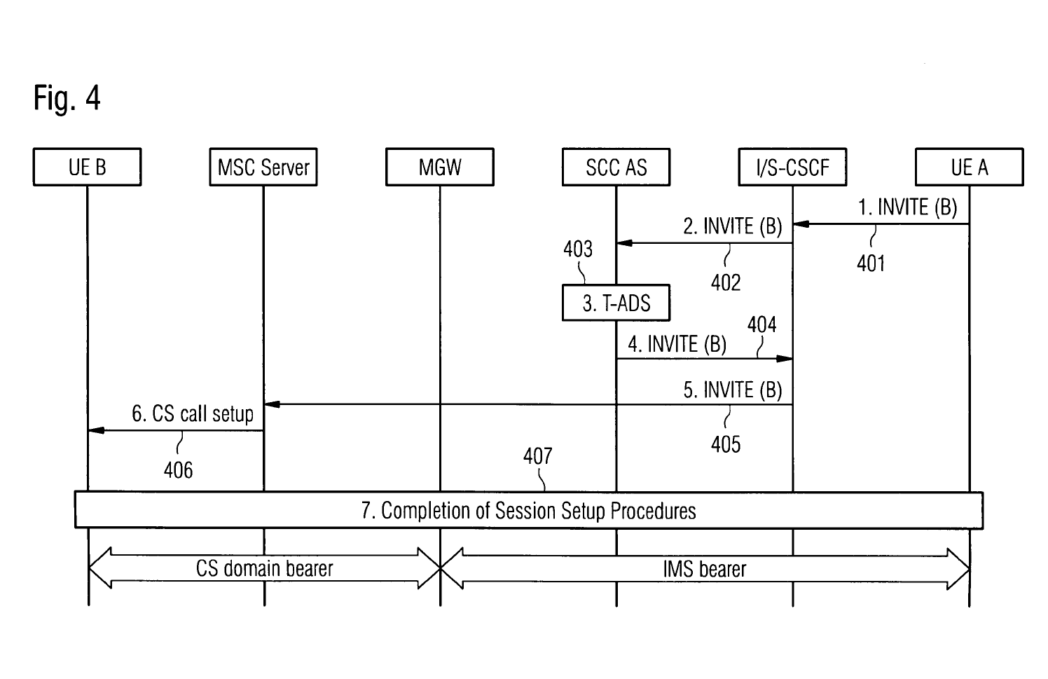

In the following a mobile terminating call is described for a user having a CS access and being registered in an IMS. The mobile terminating call is described according to FIG. 4 showing the signaling exchange between network nodes as standardized in TS 3GPP TS 23.292 V11.2.0 (2012-03), 3rd Generation Partnership Project Technical Specification Group Services and System Aspects, IP Multimedia Subsystem (IMS) centralized services, Release 11.

FIG. 4 depicts a signaling exchange for user UE A wanting to call a user UE B. Further in FIG. 4 the involved networks nodes are depicted.

All ICS user incoming sessions are directed to IMS for delivery to the ICS User. If a user is successfully registered in IMS by the MSC Server, said user has a registration binding at the I/S-CSCF containing the MSC Server as the contact address as described in respect to FIGS. 3 and 4. According to an embodiment of the present invention, the contact address stored in the S-CSCF includes further the IMSI number of the ICS user registered in the IMS, thus in this case the IMSI number of the UE B. Further, it is proposed to send the IMSI number as stored in the IMS system, namely preferably in the I/S-CSCF automatically by generation of the SIP INVITE message as parameter in said SIP INVITE message during call termination.

In the first step of FIG. 4, the calling user UE A sends a SIP INVITE message to the I/S-CSCF, 401. At first some authentication steps of the user B are performed, steps 401, 402 and 403 resulting in the provision of the contact address of the UE B. The S-CSCF performs standard service control execution procedures and sends the INVITE to the SCC AS, 402. In step 403, the SCC AS chooses the CS access network and the MSC Server contact address, amongst the registered contact addresses for the UE B, for the setup of the call. According to the present invention also the IMSI address of the UE B is provided, then after the registration phase said address is part of the user's data stored in the I/S-CSCF. Further, the SCC AS establishes a new session by sending an INVITE to the UE B via the S-CSCF, 404.

Thus, the I/S-CSCF node determines according to the dialed number the address of the contact MSC server and automatically also the IMSI number of the UE B. Consequently, the MSC Server address and the IMSI number are included in the Request-URI of the SIP INVITE message that is sent to the MSC Server, 405.

Said SIP INVITE message is generated by the S-CSCF by replacing the Request-URI as received with the registered contact address by the MSC Server enhanced for ICS during registration. Since the contact address as received in the SIP REGISTER message is used as Request-URI of SIP INVITE messages sent from IMS to the MSC Server, the IMSI of the called ICS subscriber is also returned to the MSC Server in case of terminating calls.

According to an embodiment of the invention it is proposed that the SIP INVITE message has the following format:

INVITE sip:ics234150999999999@msc2.home1.net SIP/2.0

According to this embodiment, the SIP INVITE message carries the IMSI number in the userinfo and the MSC Server address in the hostport

When a terminating SIP INVITE for an ICS subscriber is received in the MSC Server enhanced for ICS, the MSC server detects that this is a mobile terminating ICS call. Furthermore it is proposed that the MSC server preferably based on the above mentioned number prefix or string or hostport recognizes the IMSI number. In that case, the MSC extracts the called subscriber's IMSI from the Request-URI and uses the IMSI to identify the subscriber to retrieve the VLR data.

Finally, the MSC Server sends a Setup message to the UE B, 406 and the session Setup Procedure is completed, 407.

As already mentioned upon reception of the SIP INVITE message, the MSC server starts to determine the location of the called user, UE B by contacting the VLR. Because of the past location updates, the VLR knows the user since said VLR currently serves said subscriber.

However the question which occurs is, how the terminating call is to be handled in case the user is not included in the VLR. There are different possibilities of loosing the user in the VLR, for example the VLR may loss the subscriber data due to recovery actions in the MSC.

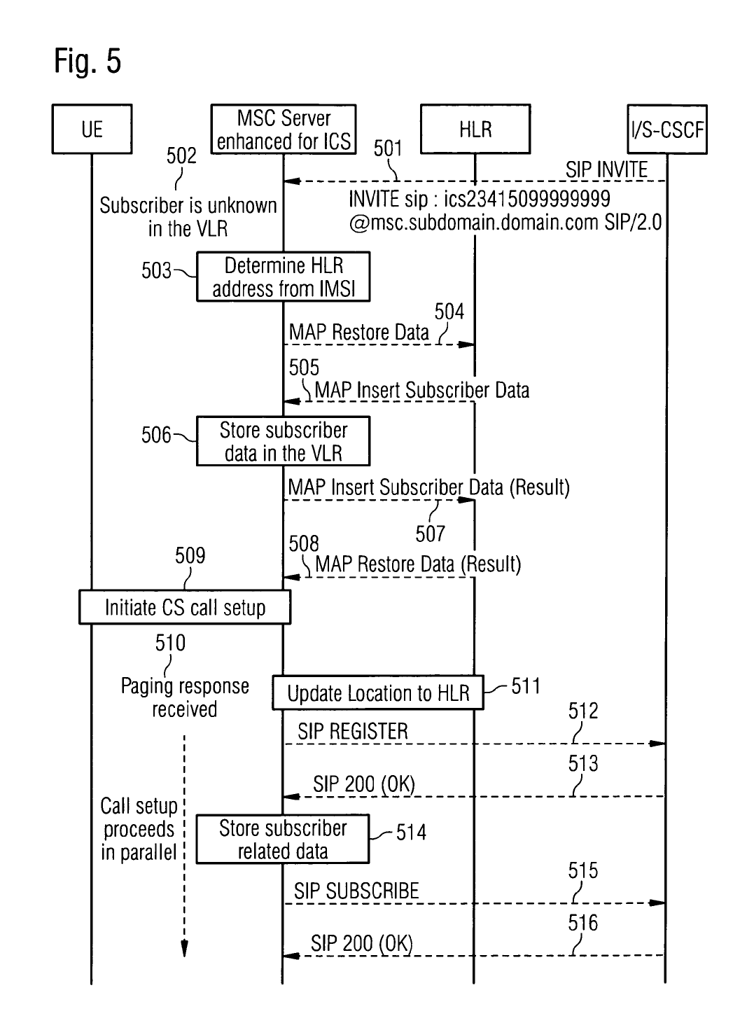

In the following an embodiment of the present invention in respect to FIG. 5 is provided, presenting a procedure for finding a user when a VLR lost subscriber data.

FIG. 5 depicts a signaling exchange between a I/S-CSCF node, MSC Server, HLR and the called user UE.

In the first step, 501 a SIP INVITE message with the IMSI address of the called user, UE is received. The MSC Server recognizes according to the included string, that the received message is a terminating call to a user with the included IMSI number. In the next step, the subscriber data in the VLR are determined. However, for example due to some errors or loss of subscriber data, the VLR may not have the data of the requested user, step 502. According to TS 3GPP TS 23.292 V11.2.0 (2012-03), 3rd Generation Partnership Project Technical Specification Group Services and System Aspects, IP Multimedia Subsystem (IMS) centralized services, Release 11, if the VLR data cannot be retrieved, the MSC Server sends a Server Internal Error response to the SIP INVITE request message indicating that the termination call failed.

According to an embodiment of the present invention it is proposed that the MSC Server uses a MAP Restore Data operation to fetch the subscriber data from the HLR.

The MAP restore data procedure for restoring data in a circuit-switched network is standardized in 3GPP TS 29.002, 3^{rd} Generation Partnership Project; Technical Specification Group Core Network and Terminals; Mobile Application Part (MAP) specification (Release 11). Said procedure is used to contact HLR in case a user can not be found in the VLR at reception of a request to provide a roaming number (MSRN) for terminating a call.

In the next step, 503 the HLR address is retrieved from the IMSI in the same way as it is done during a CS Location Update procedure for a subscriber that is not registered yet in the MSC.

In step 504, a MAP Restore Data is sent to the HLR, wherein the message carries the received IMSI number of the user. The Mobile Application Part (MAP) is a protocol which provides an application layer for the various nodes in 3G networks to communicate with each other in order to provide services to mobile users. The Mobile Application Part is the application-layer protocol used to access for example the Home Location Register, Visitor Location Register, Mobile Switching Center, or Authentication Centre

Upon reception of the MAP Restore Data message, the HLR determines the subscriber data according to the received IMSI number and provides said data in the MAP Insert Subscriber Data, 505, back to the VLR. In step 506, the received subscriber data are stored. The result of storing and updating the subscriber data in the VLR are confirmed in the HLR, 507, 508.

As next, the Call Setup Procedure in the CS is initiated as already known, 509. Thus, the UE is paged for its location and when the paging response of the mobile terminating call is received, 510, the MSC Server performs location updating to the HLR, 511. Additionally the MSC Server registers the ICS subscriber in IMS using a SIP REGISTER request, 512, 513. The registration is needed in order to get the public User Id for any call routing, like for call originating. Due to the fact, that the user's data were lost in the VLR, it is proposed to register again in IMS, in order to update the user's identifiers, in particular to send with the SIP REGISTER message the IMSI of the user towards the IMS.

Upon reception of the SIP 200 (OK) message, 513 the subscriber's data, like for example the received public User IDs are stored, 514.

Further, the MSC server may subscribe to the registration-state event package using a SIP SUBSCRIBE request, 515, 516. For example the MSC server may subscribe the user to any events influencing the registration. Thus, in case an event occurs in the IMS having an influence on the user's registration in the IMS, the MSC server is informed since said user is subscribed to such kind of events and the MSC server may change the corresponding entries.

Further it is proposed that in parallel to the registration and subscription, the call setup proceeds.

Consequently, the setup of the mobile terminating call is delayed until the subscriber data are received and stored in the VLR.

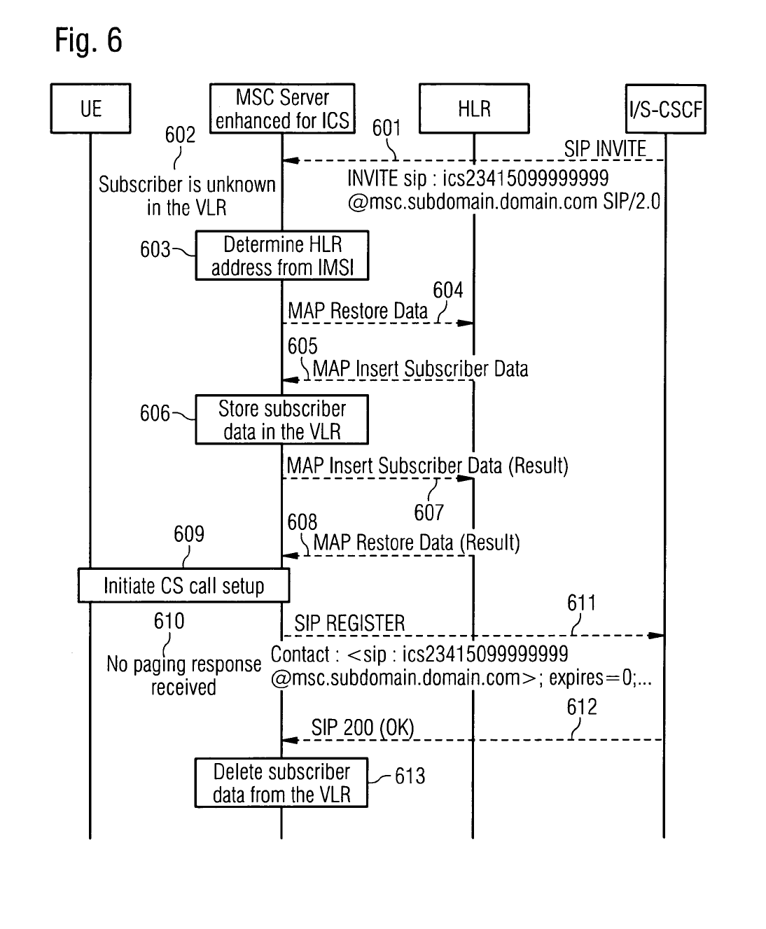

In the following an embodiment is presented in respect to FIG. 6 showing a procedure in case the user does not respond to a paging message.

There may be different reasons for not responding to a paging message either the subscriber is not roaming in the MSC area anymore or the UE is temporarily unreachable. The worst case scenario occurs when the subscriber is not roaming in the MSC area anymore, but IMS still has a valid registration with the contact address of the MSC Server and no other registration from another MSC Server is received. This may happen for example when the subscriber roams in an MSC Server, which is not enhanced for ICS.

The steps 601-609 Correspond to the step 501-509 Of FIG. 5. The difference starts with step 610.

Thus, when no paging response is received, in step 610, then it is proposed to deregister the user in the IMS. According to the standardized deregistration method, the SIP REGISTER message is used. Herein, the SIP REGISTER request comprises the value “0” as the “expires” timer, which is recognized as deregistration (otherwise, in case of registration, said value is bigger then zero). According to the present invention additionally the IMSI of the user is sent as depicted in step 611, 612. Thus, a REGISTER message is sent with the IMSI and the “expires” timer set to zero to the I/S-SCCF. Additionally the MSC server deletes the subscriber from the VLR, step 613.

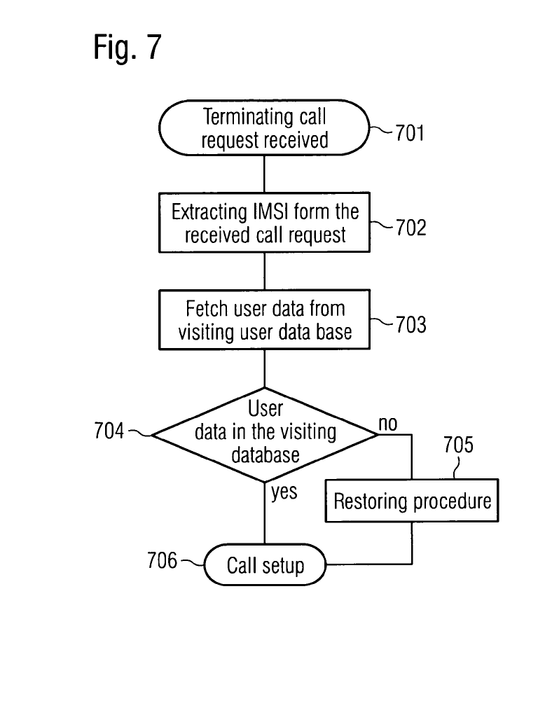

In the following a flow diagram as an embodiment of the present invention is described according to FIG. 7

In the first step a call, 701, a terminating call request is received. The reception of a SIP INVITE message serves as an example of terminating call request. In the next step, 702, the IMSI number is extracted form the terminating call request message. In step 703, user data is fetched from a VLR which serves as an example for the visiting user data base. In step, 704, the visiting data base is contacted to provide the user data required for terminating the call to said user. In case the user is in the visiting user data base, the call is terminated towards the user, otherwise a restoring procedure is carried out, 705. The result of the restoring procedure is that the user data in the visiting data base is restored by using the IMSI number as provided with the terminating call request. The IMSI number is to be provided to the IMS during the registration phase of the user in the IMS. Upon the restoring procedure is performed, the call setup is continued in order to terminate the call to the user.

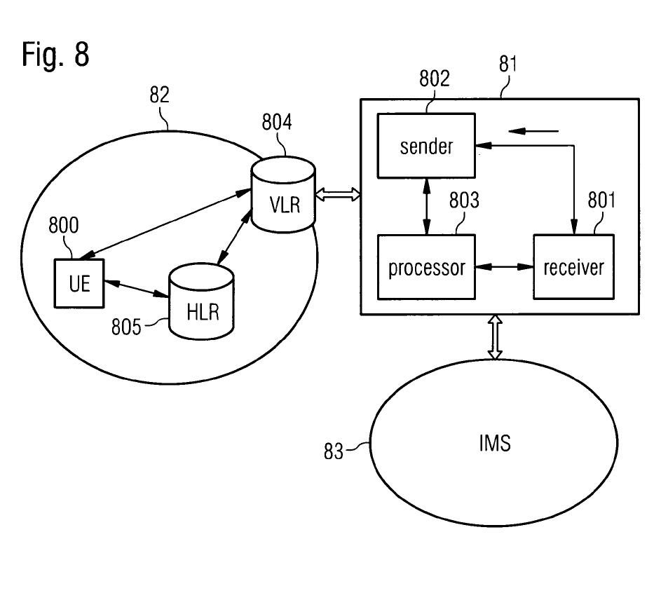

In the following an embodiment of the present invention with the functional components is described according to FIG. 8.

According to FIG. 8, there is a CS network 82 comprising a UE 800, a HLR, 805 and a VLR 804. The component 81 serves as an embodiment for the device as aforementioned. In a preferred embodiment an MSC server is the claimed device. The VLR, 81 may be provided as a separate unit or it may be integrated into the MSC Server 81. The device 81 serves as interface between a CS network 82 and the IMS network 83. However it may be located in any of the networks, preferably in the CS domain. The MSC Server, 81 comprises a receiver, 801 adapted to receive a terminating call request for the user from the IMS, wherein the request comprises an IMSI number of the user wherein the IMSI is provided to the IMS during a registering of the user in the IMS. Further there is a sender, 802 adapted to contact a subscriber visiting data base for providing user's data required for call termination using the IMSI. Preferably the VLR, 804 serves as an embodiment for the subscriber visiting data base. The processor 803 is adapted to establish the terminating call towards the user using the received user's data wherein in case the user is not found in the subscriber visiting database performing a restoring procedure by contacting a global subscriber database using the IMSI and by providing the user's data to the subscriber visiting database. The HLR, 805 serves as an embodiment of the a global subscriber database.

1. A method for terminating a call to a user in a mobile telecommunication network, the method comprising:
receiving a terminating call request for the user from an IP Multimedia Subsystem (IMS), wherein the request comprises an IMSI number of the user and wherein the IMSI is provided to the IMS during a registering of the user in the IMS,
contacting a subscriber visiting data base for providing user's data required for call termination using the IMSI,
establishing the terminating call towards the user using the received user's data,
determining whether the user's data is in the subscriber visiting database, and
in response to determining that the user's data is not found in the subscriber visiting database, performing a restoring procedure by contacting a global subscriber database using the IMSI and by providing the user's data to the subscriber visiting database.

2. The method according to claim 1, wherein the IMSI is sent in a Session Initiation Protocol (SIP) REGISTER message.

3. The method according to claim 2, wherein the IMSI number is included in the Contact header of the SIP REGISTER message in a Request SIP Uniform Resource Identifier (URI).

4. The method according to claim 1, wherein the terminating call request for the user is a SIP INVITE message.

5. The method according to claim 4 wherein the IMSI is included in the SIP INVITE message in a Request SIP URI.

6. The method according to claim 1, wherein further an indication identifying the IMSI number is provided in the corresponding message.

7. The method according to claim 6 wherein the indication is a number prefix or a dedicated string comprised in a userinfo of a corresponding message.

8. The method according to claim 6 wherein the indication is a dedicated hostport parameter comprised in a hostport of a corresponding message.

9. The method according to claim 4, wherein upon reception of the call terminating request, the IMSI number is extracted from said request.

10. The method according to claim 1 wherein the visiting subscriber data base is a VLR and the global subscriber data base is a HLR.

11. The method according to claim 1, wherein the restoring procedure comprises
contacting a HLR using MAP Restore Data and determining the user's data by using the IMSI and
using the user's data provided from the HLR to the VLR by using MAP Insert Subscriber Data.

12. The method according to claim 1, wherein the restoring procedure comprises further registering or deregistering of the user in the IMS.

13. A device adapted to terminate a call to a user in a mobile telecommunication network, the device comprising:
a receiver adapted to receive a terminating call request for the user from an IP Multimedia Subsystem (IMS), wherein the request comprises an IMSI number of the user and wherein the IMSI is provided to the IMS during a registering of the user in the IMS,
a transmitter for communicating with a subscriber visiting data base for providing user's data required for call termination using the IMSI, and
a processor adapted to establish the terminating call towards the user using the received user's data wherein in case the user is not found in the subscriber visiting database performing a restoring procedure by contacting a global subscriber database using the IMSI and by providing the user's data to the subscriber visiting database.

14. The device according to claim 13 wherein the device is a MSC Server.

15. The device according to claim 13 wherein the processor is adapted to identify the IMSI number in the received call terminating request.

16. The device according to claim 13 wherein the processor is further adapted to extract the IMSI number from the received call terminating request.

17. The device according to claim 13 wherein the processor is further adapted to:
contact a HLR using MAP Restore Data and determine the user's data by using the IMSI, and
use the user's data provided to the VLR by using MAP Insert Subscriber Data.

18. The device according to claim 1, wherein the processor is further adapted to register or deregister the user in the IMS.
